(19) United States
(12) Patent Application Publication
(10) Pub. No.: US 2008/0178394 A1
(43) Pub. Date: Jul. 31, 2008

(54) COMPOSITION AND METHOD FOR BURN OUT AND DYE TRANSFER

(76) Inventor: MICHELE L. HESTER, Waldron, MO (US)

Correspondence Address: INTELLECTUAL PROPERTY CENTER, LLC, 9233 WARD PARKWAY, SUITE 100, KANSAS CITY, MO, 64114, US

(21) Appl. No.: 12/024,096

(22) Filed: Jan. 31, 2008

Related U.S. Application Data
(60) Provisional application No. 60/898,511, filed on Jan. 31, 2007.

(51) Int. Cl. D06Q 1/02; C09K 13/06

(52) U.S. Cl. 8/114.6; 252/79.4

(57) ABSTRACT

The invention pertains to an improved fiber-removing and dye transfer process including a mixture of an acidification agent, a thickener, a solvent, a polymer and a various modifying agents for producing a design on a cellulose fiber containing material. Secondly, the invention provides an improved thermoplastic composition for use in the fiber-removing and an optional dye transfer process. The invention also provides a process for forming a continuous or patterned film on a substrate using the improved composition and for applying the improved composition in a particularized format to a substrate for selectively removing cellulose fibers and optional coloring agents.

### CROSS-REFERENCE TO RELATED APPLICATION

This application claims the benefit of the prior filed U.S. provisional application No. 60/898,511 filed Jan. 31, 2007 which is incorporated herein by reference.

### FIELD OF THE INVENTION

This invention is directed to an improved composition for removing fibers and transferring dye for use in a commercial, industrial or consumer product using a process such as burnout or Devoré to imprint a material with some indicia or color. More particularly, the composition which may include an acidification agent, a polymer, a surfactant, a humectant, a dye and a solvent in varying amounts and which may be a liquid, a film, a particle produced from the liquid or film or a combination thereof which removes cellulose fibers.

### BACKGROUND OF THE INVENTION

A Devoré or Brodier Chemeck style is used to selectively pattern a material containing cellulose fibers. Decorative patterns result from a chemical process used to remove the cellulose fibers from a material. This process involves applying a “burnout” agent to a material and activating the agent, which may occur when the burnout agent comes into physical contact with the cellulose fibers of the material or at some other time after the burnout agent is activated. It would be beneficial to utilize the burnout process on additional materials such as but not limited to fabric, paper, wood and paperboard to completely remove a section of cellulose material, to selectively remove a portion of cellulose within the material and to selectively remove the cellulose portion of a material that combines cellulose fibers with other fibers such as but not limited to wool, silk, metallic or synthetic polymer fibers, such as polyester. It would also be beneficial to utilize the burnout process for removing the cellulose and other fibers in a mixed fiber material.

One method of utilizing the Devoré process includes using a mask of resistant agent directing the burnout agent on the unmasked portion while impeding the Devoré process from the masked portion of the material. The material may then be exposed to a strong acid solution to complete the burnout, a neutralization and cleansing agent subsequently used to remove any excess acid, the resulting cellulose ash and the resistant agent.

However, using the masking process may be time consuming and require multiple applications, or the typically liquid solution may wick or bleed into undesired areas. Use of the liquid solution, may also provide for inconsistent and uneven application of the solution, causing a differential in the removal of the fibers, with areas receiving greater amounts of the solution experiencing a greater burnout in comparison to areas receiving less solution. Additionally, before the liquid burnout solution may be used, the user may be required to dry the material before the solution can be applied to the material for interaction with and removal of the cellulose fibers. Also, the ability to remove the cellulose fibers and apply an indicia or coloring agent may require multiple steps, one in which the burnout liquid is applied, activated and neutralized and removed, or rinsed from the material, the coloring agent, graphic, design or indicia being applied to the burnout material in a later step.

It therefore would be beneficial to provide a burnout composition which provides for controlled application of the burnout material, reducing the risk of uncontrolled burnout, improving the results of the burnout process, providing a method and composition for the controlled application of the burnout material which also allows the use of the burnout material on wet materials, providing a generally unitary process combining the transfer of an indicia, graphic, design or color to the cellulose containing material during the burnout process. Additionally, a method of applying the improved burnout composition is included in which a pseudoplastic or thermoplastic burnout composition, is applied to a material using a mechanical, electrical and thermal method to transfer the composition to the material. Alternatively a liquid or particulate form of the burnout composition may be applied through a printing process such as but not limited to a particulate ionized, sprayed or applied through some other printing mechanism, being applied in such a manner as to create a selective pattern, design or indicia on material during the burnout process. The composition may also be applied to a substrate such as a thermal transfer paper prior to the burnout process. Additionally, the invention provides a method of selectively transferring a dye, indicia, design, graphic or pattern using the burnout process.

### SUMMARY OF THE INVENTION

The present invention resolves the problems outlined above by providing a burnout, dye transfer composition having a relatively stable shelf life in a form amenable to mechanical, electrical, thermal transfer, or other transfer method for applying the improved composition to a material, such as but not limited to fabric, paper, wood and paperboard in a form adapted for selective patterning or printing the material. Additionally, the improved composition may be used in a form adapted for making thermal transfer papers which include the improved burnout composition adapted for receipt by the material. Additionally, the invention involves a method of using this composition, which does not require the on-site mixing of bulk chemicals and consequently making the method of selective dye transfer with the burnout process available to individual craft users and non-industrial users.

The invention pertains to an improved fiber-removing and dye transfer composition including a liquid composition with a dye, a burnout agent, a thickener, a solvent, a polymer and a modifying agent which transfers dye and produces a pattern using a mechanical, chemical, electrical or thermo-processing type process. Secondly, the invention provides the liquid composition described above which may be processed into a film or thermoplastic for use in the fiber-removing, dye transfer process. Thirdly, the invention provides a continuous or patterned film which may be used in the burnout, dye transfer process. Fourthly, the invention provides particles comprised from the fiber-removing and dye transfer composition which may be used in the burnout, dye transfer process. Fifthly, the invention provides a process of making the fiber-removing and dye transfer composition which may be used in the burnout, dye transfer process. Sixthly, the invention provides a process for transferring dye to a material using a fiber-removing and dye transfer composition with a subsequent process occurring in the burnout, dye transfer process, such as thermally activating the composition for transfer. Seventh, the invention provides a process for forming a continuous or patterned film on a material or transfer paper using the particles in a solvent or in a solid form or produced by a mechanical, printing, electrical or thermal process.

### BRIEF DESCRIPTION OF THE DRAWINGS

The drawings constitute a part of this invention and include exemplary embodiments of the present invention and illustrate various objects and features thereof

FIG. 1 is a front view of various patterned films imprinted onto a substrate.

FIG. 2 is a cross-section of the film taken along line 2′-2′ of FIG. 1 as received by a material.

FIG. 3 is a plan view of a material apparel item receiving the film of FIG. 1.

FIGS. 4a, 4b, 4c are three different cross-sections taken along lines 4a-4a in FIG. 3 representing the different applications of the improved burnout composition to various materials or alternatively in varying conditions.

FIG. 5 is a plan view of the apparel item receiving the shaped film of FIG. 1 from the substrate.

FIGS. 6a-6b is a cross section of the material receiving a film and a dye, both before and after the burnout process, taken along line 6′-6′ of FIG. 5.

FIGS. 7a-7b is a cross section of the material receiving a dyed film, both before and after the burnout process, showing material patterning and dye transfer taken along line 7-7 of FIG. 5.

### DETAILED DESCRIPTION

### I. Introduction

As required, detailed embodiments of the present invention are disclosed herein; however, it is to be understood that the disclosed embodiments are merely exemplary of the invention, which may be embodied in various forms. Therefore, the specific compositions, methods, structural and functional details disclosed herein are not to be interpreted as limiting, but merely as a basis for the claims and as a representative basis for teaching one skilled in the art to variously employ the present invention in virtually any appropriately detailed structure.

### II. Composition for Burn Out and Dye Transfer

The present invention provides a liquid, solid, pseudoplastic, thermoplastic or particulate formulation for the introduction of an acid, with or without dye in a continuous or patterned form to produce a burnout pattern on material such as but not limited to fabric, paper, wood and paperboard, containing a plurality of cellulose fibers. The action of the acid, with or without dye, is to produce a pattern on a material containing cellulose fiber by completely or selectively carbonizing the cellulose fibers via a dehydration reaction as illustrated in the following general chemical reaction equation:

—[HCOH]−(cellulose)+NaHSO₄→[C (carbon ash)+H₂O+Na⁺+SO₄²⁻

The selectivity of the process may be determined by the amount of an acidic agent, such as but not limited to sodium bisulfate, the contact time between the acidic agent and the cellulose, and the amount or temperature of heat applied during a finishing process, thickness of the film or other considerations. Patterning of the material or creation of an indicia on the material (sometimes referred to herein as printing), may be accomplished in a chemical application by applying a composition in a manual, mechanical or electrical manner to the cellulose containing material. Prior to the application of the composition to the material, the composition may be arranged into a desired pattern. In addition, the process may be completed by utilizing a finishing process using heat such as steam, hot air or warming plates on the composition received by the material.

As previously described in applicant's prior U.S. Pat. No. 5,417,754, incorporated herein by reference, the Devoré or burnout process may be accomplished by using the acidic agent, such as sodium bisulfate (NaHSO₄), sodium aluminum sulfate (NaAl(SO₄)₂) or other comparable acids. In addition, additives may be added to the composition including: a solvent, such as but not limited to, water, ethanol and methanol for mixing and transmitting the composition to the material using manual, mechanical or electrical methods; a thickening agent, such as but not limited to carrageenan, microcrystalline cellulose, pectin, hypromellose, xanthan gum and polysorbate-80, may be used to modify the formulation for exhibiting pseudoplastic or thermoplastic properties; a humectant, such as but not limited to, glycerine and dextrose may be used to retain moisture and assist in the Devoré process; a polymer, such as but not limited to, pectin, polyvinylalcohol, polyethylene glycol, sodium polystyrene and sulfonate, may be used to adapt the composition for use with the acidic agent and to assist in providing pseudoplastic or thermoplastic properties, a coloring agent such as a dye, ink or pigment may be used for coloring the material; and a surfactant, such as but not limited to, sodium lauryl sulfate, anionic surfactant, cationic surfactant, amphoteric surfactant and non-ionic surfactant may be used for converting the formulation to an emulsion.

The additives provide enhanced transmission of the acidic agent and dye to the material for the Devoré process and for binding the components together in the form of a film or plural particles, providing superior burnout, dye transfer and subsequent processing.

In accordance with the scope of the invention each part may be used alone or in combination with other parts or alone or in combination with a thermal, mechanical, chemical, electrical or printing process for providing a pattern or other indicia to material in the Devoré process.

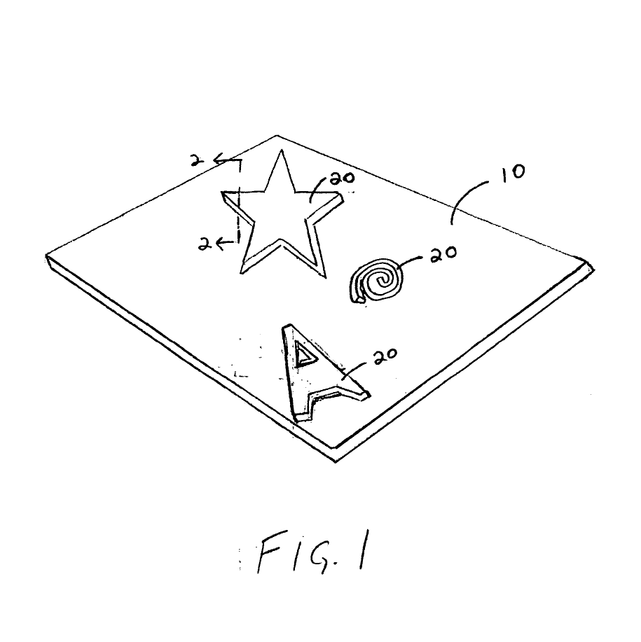

Referring now to the drawings in general and FIG. 1 in particular, a patterned film generally referred to as reference numeral 20 is illustrated in association with a substrate 10, although the invention may be used with or without the substrate 10. The film 20 is generally made from the composition including the acidic agent, solvent, thickening agent, polymer, and other modifying agents such as humectants, dyes and surfactants. As further described below, the composition may be formulated in a liquid state and evaporated or allowed to dry for a period of time to form the film 20. Additionally, the liquid composition may be shaped into a selected configuration and thereafter evaporated or dried forming a film having the selected shape. Alternatively, the composition may be utilized in the liquid state without being formed into the film 20.

Use of the composition as a film provides several benefits in that the film is more easily cut or shaped into a pattern or other indicia, providing a clearly defined area for the carbonization of the cellulose fibers limiting any wicking effect which is common for the liquid composition. In addition, use of the film composition may be more adapted for die-cut patterns or silk-screening and may help reduce associated wet processes typical with the Devoré process. The film provides a uniform layer with a relatively smooth surface adapted for receiving dyes or printed indicia at greater resolutions than traditional fabrics. In addition, the film composition can be mechanically transmitted through a printing machine such as a printer achieving better results in comparison to traditional fabrics or fiber based materials.

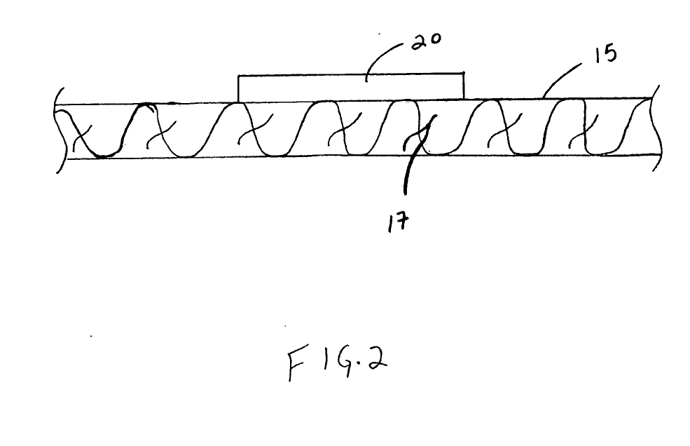

If the composition is formed into the film 20, it may then be fashioned into various shapes or indicia as desired and applied directly to the cellulose containing material 15, illustrated in FIG. 2, or to the substrate 10 which receives the film 20, transferring the film 20 to the cellulose containing material 15, facilitating the Devoré process.

FIG. 2 illustrates the film at least partially overlaying the material 15 with plural cellulose fibers 17. Upon receipt of the film 20, the Devoré process may begin with the cellulose fibers 17 cooperating with the acidic agent of the film 20 composition. Upon completion of the Devoré process or upon the termination of the process, the material 15 may be rinsed in a neutralizing agent, such as but not limited to water, removing any resulting ash from the material 15, the material 15 displaying an indicia corresponding to the area receiving the film composition 20.

The concentration of the various ingredients depends on the nature of the ingredients. As a general rule, the concentration is selected to be high enough for selective remove the cellulose fibers, but without being excessive since that would lead to a material that is fragile (brittle) and rigid.

To initiate the Devoré process, a heat source may be applied to the composition. In addition depending on the hydration of the composition, which may be modified by adding humectant or water, additional hydration may be utilized to activate or expedite the process. Optionally, a moisture containing layer containing humectant, water or the like, may be associated with the material for hydrating the material, the composition or both during Devoré process.

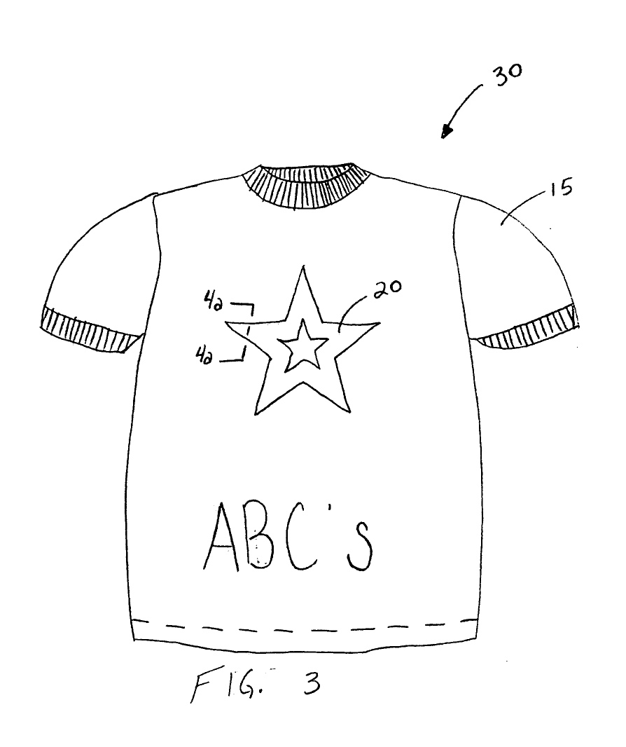

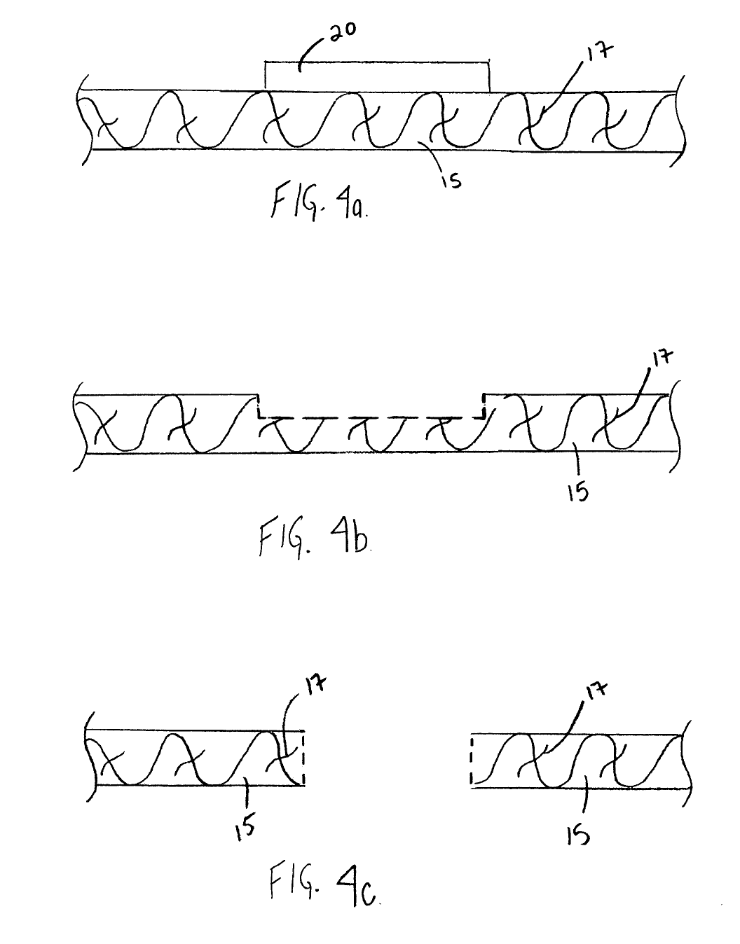

An apparel item 30 at least partially composed of cellulose containing material 15 is illustrated in FIG. 3 at least partially receiving the film composition 20. The film composition 20 is fashioned to represent indicia, graphic, design or pattern. Depending on the strength of the composition, the duration of contact between the composition and the apparel item 30, and other considerations, the Devoré process resulting from the cooperation between the film composition 20 and the apparel item 30, illustrated in FIG. 4a, may vary.

A partial removal of the cellulose fibers 17 from the material 15 is illustrated in FIG. 4b in which the cellulose fibers are selectively removed from a combination cellulose and other fiber material, or alternatively, a portion of the cellulose fibers within a cellulose fiber material may also be removed. A substantially complete removal of the cellulose 17 and other material 15 fibers within the apparel item 30 is illustrated in FIG. 4c. The fibers 17 in FIG. 4c have been removed more than the fibers 17 in FIG. 4b potentially as a result of more reaction time between the film composition 20 and the material 15, more film composition 20 or a stronger concentrate of the acidic agent within the film composition 20.

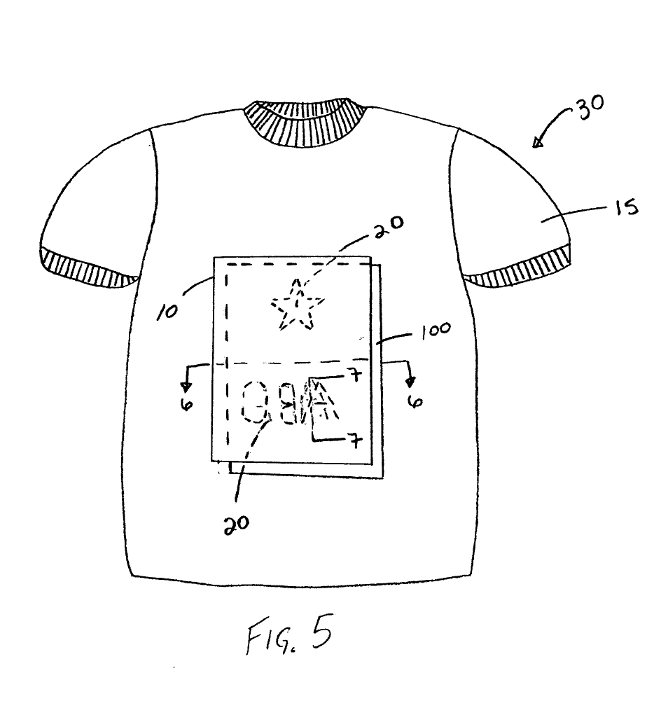

Alternatively, as illustrated in FIG. 5 using a substrate 10 such as a thermally activated release substrate, the film 20 may be associated with the substrate 10 for application to the item of apparel 30. To release the film 20, a heat source may be associated with the substrate 10 releasing the film 20 from the substrate 10 onto the apparel item 30. In addition, a heat source may be applied to the film 20 after removal of the substrate 10 from the film 20, facilitating the Devoré process between the film 20 and the material 15.

The heat source for activation may be provided with a heat press or heated plate, or with a steam iron which may also provide moisture for hydrating the film. The temperature should generally be kept constant and after the initial application, should not rise too fast to ensure that the cellulose is degraded under controlled conditions, but be of sufficient level for activation.

An alternative embodiment may include overlaying the film composition with a porous substrate such as, but not limited to, bond paper. This overlay combination may be activated by applying heat, and optionally moisture, to the porous substrate portion. Activating the porous substrate overlying the film composition may affix the substrate to the film composition during the Devoré Process. After the burn-out process has terminated, the porous substrate-composition combination may be removed along with a portion or portions of any remaining film and carbonized material affixed thereto prior to neutralizing or rinsing the material. In this way, rinsing may occur more easily and quickly, requiring less agent to neutralize the burnout process.

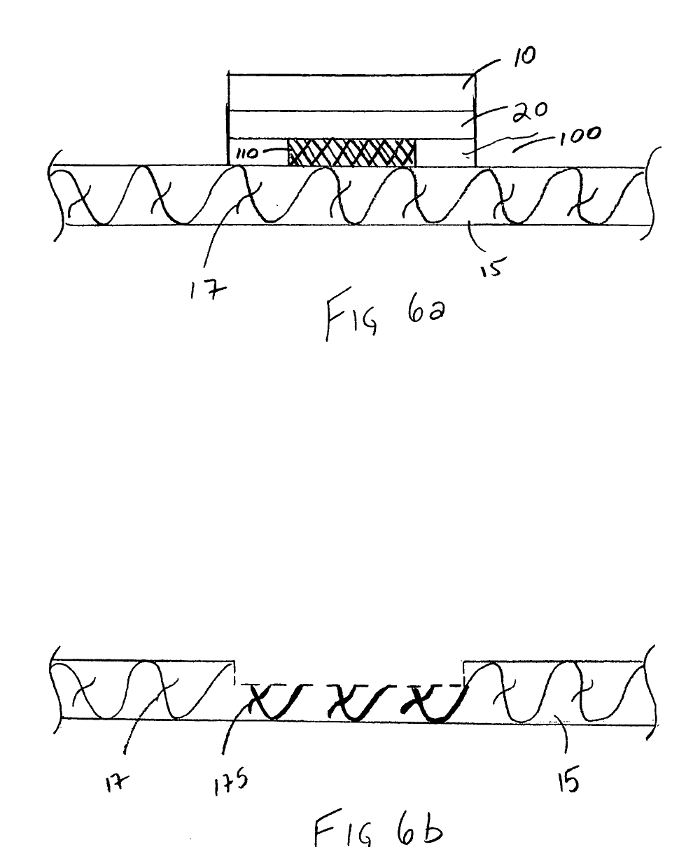

Optionally, as indicated in FIGS. 5-6b, an alternative substrate 100 may be provided having a colored surface or a visual indicia, graphic or design 10 which receives the film 20. In this way, the color, indicia or graphic 110 may be transferred to the film 20 or directly transferred to the material 15 during the Devoré process. FIG. 6b illustrates the transfer of the color (or other visual indicia) onto a portion of the remaining cellulose fibers 175.

A method for applying the composition 20 to a substrate to form an indicia may include providing a material adapted to receive the improved fiber etching composition, formed from mixing the acidification agent, thickening agent, solvent and polymer together into a thermoplastic composition, such as a film. Once the composition is formed, it may be arranged into, but not limited to, various shapes and applied to the material. At least a portion of the thermoplastic composition applied to the cellulose fibers is then heated to a temperature for a sufficient period to activate the Devoré process. After the conclusion of the Devoré process, a design is presented by the remaining material. The thermoplastic composition may be formed into a film by dehydrating the composition, with the film then being arranged into an indicia, design or other pattern. After the conclusion of the Devoré process any remaining thermoplastic composition may be removed from the material by rinsing with a neutralizing agent.

Rinsing may be performed in water or other another solvent agent and can include a first stage of solubilizing the ingredients of the composition present in excess on the final material, followed by a second stage of rinsing. Rinsing makes it possible to eliminate not only the residual composition, but also eliminates the products of carbonized cellulose material.

In an alternative embodiment, the film 20 may be formed on a alternative substrate 100, as illustrated in FIG. 6a. The alternative substrate 100 includes a coloring agent, graphic indicia, design or pattern 110, whereby the substrate 100 provides the coloring agent, graphic, indicia, design or pattern 110 to the film 20 for transfer to the material 15 during the Devoré process. When the film 20 with the graphic 110 containing substrate 100 is applied to the material 15, the film may be heated initiating the Devoré process, the graphic 110 is then transferred to the material 15 including the cellulose or non-cellulose fibers, during the Devoré process as illustrated in FIG. 6b.

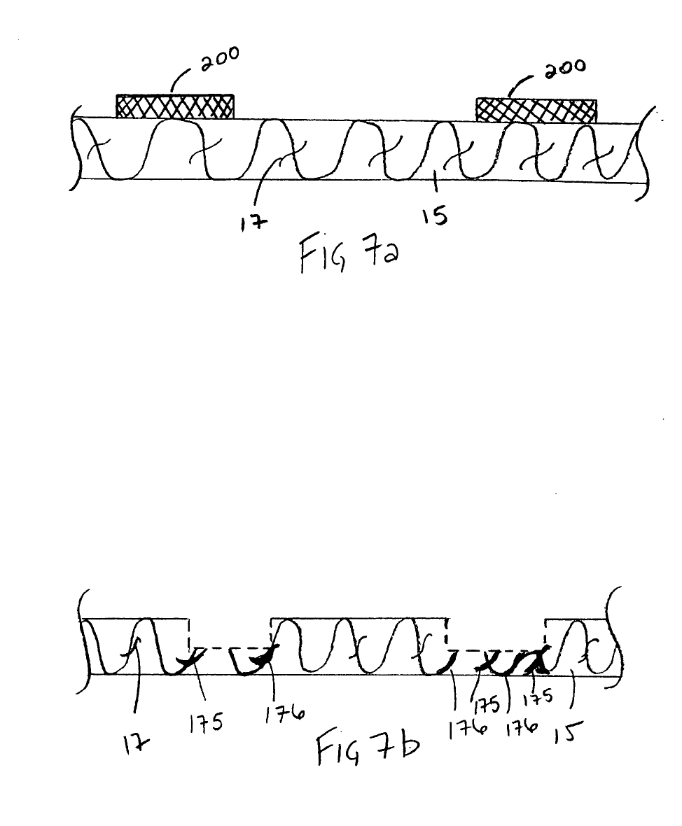

Optionally, the alternative substrate 100 containing the coloring agent, graphic, indicia, design or pattern 110 may be received by the film 20 or received by the film composition before the film 200 has formed as illustrated in FIG. 7a. When the film 200 with the coloring agent, graphic indicia, design or pattern 110 is applied to the material 15, the film may be heated initiating the Devoré process, the graphic 110 generally being transferred to the material 15 including the cellulose 175 or non-cellulose 176 fibers, during the Devoré process as illustrated in FIG. 7b.

Another alternative method of applying the film 20 to the material 15 may include forming the film into plural particles or forming the film and then modifying the film into a particle format such as, but not as a limitation, by mechanically mixing the film until it is reduced in size allowing it to be dispensed as a particle onto the material 15.

By example and not as a limitation, U.S. Pat. No. 6,495,241 incorporated in its entirety herein by reference, illustrated an image-transfer printing process which permits the transfer of images onto materials. In an alternative embodiment, the improved thermoplastic composition may be formed into a particulate form and transmitted through an inkjet nozzle, as is generally known and as further described in U.S. Pat. No. 4,959,661 and incorporated herein by reference (for example, but not as a limitation) directly onto material or the substrate for transfer to the material. In accordance with this another alternative aspect of this embodiment, coloring agents may be printed onto the improved thermoplastic film composition fed through an inkjet printing device or the improved thermoplastic composition may be printed directly onto the material or substrate fed through the inkjet printing device either as a liquid or as a mixture of particles in a carrying solvent similar to those methods described in the above referenced patents in connection with an ink-jet printing process.

Once the composition has been formed into plural particles, the particles may be applied to a sheet or substrate with or without a coloring agent, graphic design, indicia or pattern using a process like printing, where the substrate may be electrically charged to receive the oppositely charged film particles in a selected position. The film particles may then be fixed to the substrate such as by heating or applying an adhesive to the film particles on the substrate. The film may then be applied to the material and the Devoré process initiated. Upon applying the film particles to the material, the particles may transmit the coloring agent, graphic design, indicia, or pattern from the underlying substrate with which they were affixed to, to the material. Alternatively, the particles may be associated with colored particles during the application of the particles to the substrate or the particles with or without the coloring agent may be directly applied to the material in an alternative material printing process.

### III. EXAMPLES

### Example 1

In order to demonstrate the effectiveness of the technical teaching according to the invention, tests were carried out on the present invention. To this end a pseudoplastic liquid composition was formed including 1.5 grams of a polysaccharide such as, but not limited to, xanthan gum, locust bean gum, carrageenan or the like, 15 grams of an acidic salt such as but not limited to sodium bisulfate, 4 grams of a humectant such as but not limited to glycerin, and 79.5 grams of water, aging the composition 24-72 hours. A heated mixture (heated to 125° F.) of 40 grams of polyvinyl alcohol (Celvol® 24-203, distributed by Celanese, Ltd.) and 10 grams of sodium lauryl sulfate such as but not limited to Stepanol® WA-Paste distributed by Stepanol Company may be added to the composition. A disperse dye such as the PROsperse Scarlet D350 offered by Pro Chemical & Dye, was added to the mixture and stirred to homogeneity. The pseudoplastic mixture was then applied directly on a material containing cellulose fiber for the simultaneous action of patterning the material through the Devoré process while, imprinting an indicia upon the material. It was also determined that the mixture may be distributed uniformly on a flat or patterned substrate providing a film which could be used to pattern the material while imprinting indicia upon the material.

### Example 2

An additional test was conducted by creating a pseudoplastic liquid composition including 6 grams of pectin acting as a combination polysaccharide i.e. a thickening agent and polymer (Genu® Pectin, 150 USA-SAG type B rapid set, commercially available from CP Kelco ApS, a Division of CP Kelco Incorporated) and 94 grams boiling water vortexed in a high speed blender. To this solution 15 grams of an acidic agent such as aluminum sulfate (pulverized) may be added, along with 20 grams of dextrose, a modifying agent, immediately vortexed in a high speed blender. The composition was applied to the material, preferably immediately after vortexed, for patterning the material through the Devoré process. Alternatively, the composition may be spread on a film forming substrate coated with a non-stick surface such as Teflon®, (Teflon® is a brand name and a registered trademark of E. I. du Pont de Nemours and Company), on a substantially planar surface, being generally flexible such as, but not limited to, acetate, Mylar, transfer paper or other non-porous surface for the purpose of forming the film. To decrease the viscosity, up to 80 grams of boiling water may be added, as desired, to the composition. By decreasing the viscosity of the composition, the pouring or spreading of the composition may be improved allowing it to be applied to the substrate for the purpose of forming the film.

### Example 3

Still another test was conducted related to forming a dehydrated pseudoplastic liquid composition from the composition of EXAMPLE 1, pouring it on a substantially planar surface and placing it within a convection oven at 125 deg F. until a flexible film is formed, approximately 12 hours. The formed film may be flexible while exhibiting a heterogeneous composition consisting of regions of a white material overlying a colored film.

In the bulk portion of the colored film, the colored film is of uniform color (purple) and composition with inorganic salts, such as but not limited to sodium bisulfate uniformly covering the surface of the film and penetrating the film. The bottom surface of the bulk film, formerly contacting the substrate, is uniform and devoid of inorganic salts. The average thickness of the bulk portion of the film is 10 microns as measured with a scale under a stereomicroscope with a 20× magnification. Due to differential drying, the edges of the film exhibit decreasing and variable thickness and inhomogeneous distributions of dye, inorganic salts and the polymer film. As tested using a film-acid testing process discussed below, the bulk portion of the film contains 0.011 milliequivalents of acid per square centimeter.

### Example 4

Another film was created as a dehydrated pseudoplastic liquid composition including 1.5 grams of a polysaccharide such as, but not limited to, xanthan gum, locust bean gum, carrageenan or the like, 15 grams of an acidic salt such as but not limited to sodium bisulfate, 4 grams of a humectant such as but not limited to glycerin, and 79.5 grams of water, aged 24-72 hours. A heated mixture (heated to 125° F.) of 40 grams of polyvinyl alcohol (Celvol® 24-203, distributed by Celanese, Ltd.) and 10 grams of sodium lauryl sulfate such as but not limited to Stepanol® WA-Paste distributed by Stepanol Company are added to the composition. The composition is then stirred to homogeneity, poured on a substantially planar surface and placed within a convection oven at 125 deg F. until a flexible film is formed, approximately 12 hours later. Dye may be manually applied to the surface of the film, using a permanent ink material pen such as, but not limited to Identipen™ Permanent Marker, made by Sakura of America. The resultant heterogeneous film is flexible, the bulk portion of the film is of uniform color (white) and composition with some inorganic salt crystals uniformly covering and penetrating the film's top surface. As applied, the dye is generally located on the film's top surface, exhibiting a small amount of lateral bleed. In general, dye bleed through the film is absent. Indentations resulting from air bubbles with sizes 10-30 microns as measured using a scale with a stereomicroscope are randomly distributed on the film's surface. The bottom surface of the bulk film, formerly in contact with the substrate, is uniform and devoid of the applied dye, inorganic salt crystals and indentations. The average thickness of the bulk portion of the film is 5 microns. Due to differential drying, the edges of the film exhibit decreasing and variable thickness and inhomogeneous distributions of inorganic salts and polymer. As tested using the film-acid testing process, the bulk film contains 0.046 milliequivalents of acid per square centimeter.

### Example 5

A dehydrated pseudoplastic liquid composition adapted to receive a particulate dye was developed from a composition including 1.5 grams of a polysaccharide such as, but not limited to, xanthan gum, locust bean gum, carrageenan or the like, 15 grams of an acidic salt such as but not limited to sodium bisulfate, 4 grams of a humectant such as but not limited to glycerin, and 79.5 grams of water, aged 24-72 hours. A heated mixture (heated to 125° F.) of 40 grams of polyvinyl alcohol (Celvol® 24-203, distributed by Celanese, Ltd.) and 10 grams of sodium lauryl sulfate such as, but not limited to, Stepanol® WA-Paste distributed by Stepanol Company may be added to the composition. The composition is then stirred to homogeneity, poured on a substantially planar surface and a particulate form of a direct dye (Bright Blue, Aljo Mfg. Co.) may be applied to the surface of the wet film and manually distributed throughout the film surface to provide a heterogeneous film. The wet film is then placed within a convection oven at 125 deg F. until a generally dry flexible film is formed, approximately 12 hours later. The resultant film is generally flexible, the bulk portion of the heterogeneous film appearing as a whitish colored film with a random distribution of dye particles and inorganic salts penetrated and on the film's surface. The dye exhibits some lateral bleed, or partial dissolution in the mixture. The dye particles may be flattened and exhibit a size distribution of 1-30 microns in the dimension of the film surface and may completely penetrate the film. The bottom surface of the bulk film, formerly in contact with the substrate, may exhibit a random distribution of dye particles that completely penetrates the film and is devoid of inorganic salts or crystals. The average thickness of the bulk portion of the film is 10 microns. The edges of the film exhibit decreasing and variable thickness, cracking and inhomogeneous distributions inorganic salts and polymer due to differential drying. As tested using the film-acid testing process, the bulk film contains 0.057 milliequivalents of acid per square centimeter.

### Example 6

Particles were formed from a dehydrated pseudoplastic liquid composition formed form the composition of EXAMPLE 3 after the mixture is dehydrated into the film. Film particles may be derived from mechanically grinding the film. The resultant flat particles are irregular and have an average thickness of about 10 microns, but are distributed in widths which in general range from 10 microns to 5 millimeters. The particle form of the film may be dispersed such as spraying onto a substrate and fixed, adhered or otherwise secured to the substrate for creating a desired pattern. Optionally, the substrate may be colored with the dye, or it may contain an image, graphic or other indicia. Once the fixed particle film is formed overlying the substrate, the film containing substrate may be applied to material for simultaneously creating a pattern and apply a graphic or indicia to the material during the Devoré process.

In analyzing the formed films developed in the examples described above, some of the film's acid content was measured using the film-acid test in the following manner: providing a 1 cm×1 cm±0.2 cm (in either dimension) portion of the bulk film, using a sharp edge. The film portion was then placed in 25.00 mL of doubly deionized water with an initial pH of 6.00 (unstable), at room temperature (22° C.). The film was left submerged in the doubly deionized water for two (2) hours in an effort to liberate the acid from the film. During the submersion process, the film softened but did not completely dissolve within the time allowed. After the two hour time period, the pH of the solution was measured and converted to concentration of protons [H⁺] milliequivalents (meq) of acid per square centimeter based on the initial water volume. The amount of acid present in the water initially was less than 0.00003 meq, and therefore was not considered in the final calculation.

While the invention has been described in connection with specific embodiments thereof, it will be understood that it is capable of further modifications and this application is intended to cover any variations, uses, or adaptations of the invention following, in general, the principles of the invention and including such departures from the present application as come within known or customary practice within the art to which the invention pertains and as may be applied to the essential features herein before set forth.

Having thus described the invention, what is claimed as new and desired to be secured by Letters Patent is:

1. An improved decorative composition providing a design on a material by selectively removing cellulose fibers from the material containing such fibers, said decorative composition being formed from a mixture of ingredients comprising an acidification agent, a thickening agent, a solvent, a polymer and modifying agents wherein said ingredients form a substantially homogeneous mixture for selectively carbonizing the cellulose fibers of the material presenting the design.

2. The composition as set forth in claim 1 wherein:
said acidification agent is selected from the group consisting of sodium bisulfate and sodium aluminum sulfate;
said thickening agent is selected from the group consisting of carrageenan, microcrystalline cellulose, pectin, hypromellose, xanthan gum and polysorbate-80,
said solvent is selected from the group consisting of water, ethanol and methanol, and
said polymer is selected from the group consisting of pectin, polyvinylalcohol, polyethylene glycol, sodium polystyrene and sulfonate.

3. The composition as set forth in claim 1 wherein said modifying agents are selected from the group consisting of a humectant, pigment or surfactant.

4. The composition as set forth in claim 3 wherein:
said humectant is further selected from the group consisting of glycerine and dextrose,
said pigment is further selected from the group consisting of indigo, aniline, and dye, and
said surfactant is further selected from the group of sodium lauryl sulfate, anionic surfactant, cationic surfactant, amphoteric surfactant and non-ionic surfactant.

5. The composition as set forth in claim 1 wherein said composition is a thermoplastic solid.

6. The composition as set forth in claim 5 wherein said thermoplastic solid is a continuous film.

7. The composition as set forth in claim 5 wherein said thermoplastic solid is a particulate form.

8. An improved method for selectively removing cellulose fibers from a material, comprising the steps of:
providing a composition formed from the mixture of an acidification agent, a thickening agent, a solvent and a polymer to form a thermoplastic film composition,
arranging the thermoplastic film composition as desired
applying the arranged composition to the material, and
heating at least a portion of the film applied to the cellulose fibers to an elevated temperature for a sufficient period thereby presenting a design in the material.

9. The method of claim 8 further comprising:
said material having cellulose and non-cellulose fibers, and
said composition further comprising a coloring agent whereby said coloring agent is selectively transmitted to the remaining material after the heating step.

10. The method of claim 8 further comprising:
said material having cellulose and non-cellulose fibers, and
said composition further comprising a coloring agent whereby said coloring agent is selectively transmitted to the material simultaneously with the heating step.

11. The method of claim 8 wherein said thermoplastic film is formed by dehydrating the composition.

12. The method of claim 8 further comprising the step of associating the film composition with a substrate prior to the arranging step whereby the composition is released from the substrate and applied to the material.

13. The method of claim 12 wherein said substrate further comprises a coloring agent transmitted to said material by said film composition.

14. The method of claim 12 wherein said substrate further comprises a visual indicia whereby said visual indicia is transmitted to said material by said film composition.

15. An improved method for selectively removing cellulose fibers from a material, comprising the steps of:
providing a material adapted for receiving a composition formed from the mixture of an acidification agent, a thickening agent, a solvent and a polymer formed into a particulate thermoplastic composition,
applying the particulate thermoplastic composition on the material using an inkjet printing process with the particulate thermoplastic composition transmitted through an inkjet printing nozzle onto the material, and
heating least a portion of the particulate thermoplastic composition applied to the cellulose fibers to an elevated temperature for a sufficient period thereby presenting a design in the material.

16. The method according to claim 15 wherein said composition further comprises a coloring agent.

17. The method according to claim 15 wherein said substrate further comprises a visual indicia.

18. An improved method for selectively removing cellulose fibers from a material, comprising the steps of:
providing a substrate adapted for receiving a composition formed from the mixture of an acidification agent, a thickening agent, a solvent and a polymer formed into a particulate thermoplastic composition,
applying the particulate thermoplastic composition on the substrate using an inkjet printing process with the particulate thermoplastic composition transmitted through an inkjet printing nozzle onto the substrate,
sandwiching the thermoplastic composition between the material and the substrate, whereby the thermoplastic composition is associated with the cellulose fibers, and
heating at least a portion of the particulate thermoplastic composition applied to the cellulose fibers to an elevated temperature for a sufficient period thereby presenting a design in the material.

19. The method according to claim 18 wherein said composition further comprises a coloring agent.

20. The method according to claim 18 wherein said substrate further comprises a visual indicia.

21. An improved method for selectively removing cellulose fibers from a material, comprising the steps of:
providing a thermoplastic film composition formed from the mixture of an acidification agent, a thickening agent, a solvent and a polymer,
applying a coloring agent using an inkjet printing process on the thermoplastic composition fed through an inkjet printing device,
sandwiching the coloring agent between the material and the thermoplastic film composition whereby the thermoplastic composition is associated with the cellulose fibers, and
heating at least a portion of the thermoplastic film composition to an elevated temperature for a sufficient period thereby presenting a design in the material.
